(19) United States
(12) Patent Application Publication
(10) Pub. No.: US 2009/0232060 A1
(43) Pub. Date: Sep. 17, 2009

(54) METHOD, WIRELESS COMMUNICATION SYSTEM, COMMUNICATION APPARATUS, AND TANGIBLE MACHINE-READABLE MEDIUM FOR ESTABLISHING A ROUTING PATH DURING A NETWORK ENTRY PROCESS OF A SUBSCRIBER STATION BASED ON A MULTI-HOP RELAY STANDARD

(75) Inventors: Kan-chei Loa, Taipei (TW); Yung-Ting Lee, Taipei (TW); Chun-Yen Hsu, Min-Syong Hsiang (TW); Hua-Chiang Yin, Guei-Shan Township (TW); Yi-Hsueh Tsai, Ban-Chiao (TW)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: INSTITUTE FOR INFORMATION INDUSTRY, Taipei (TW)

(21) Appl. No.: 12/048,732

(22) Filed: Mar. 14, 2008

(51) Int. Cl. H04Q 7/00; H04L 12/28

(52) U.S. Cl. 370/329; 370/351

(57) ABSTRACT

A method, a wireless communication system, a communication apparatus, and a tangible machine-readable medium for establishing a routing path during a network entry process of an SS based on a multi-hop relay standard are provided. The wireless communication system comprises a BS, an SS, and an RS. The SS transmits an RNG-REQ of the SS to the RS with a ranging CID. The RS allocates an SS CID for the SS, and transmits an RNG-RSP having the SS CID to the SS with the ranging CID. Then the SS transmits an SBC-REQ with the SS CID to the BS through the RS. Finally, the BS transmits an SBC-RSP to the SS through the RS after receiving the SBC-REQ. The routing path of the SS is updated into a routing table of the RS according to one of the SBC-REQ and the SBC-RSP.

### CROSS-REFERENCES TO RELATED APPLICATIONS

Not applicable.

### BACKGROUND OF THE INVENTION

1. Field of the Invention

The present invention relates to a method, a wireless communication system, a communication apparatus, and a tangible machine-readable medium for establishing a routing path. More specifically, the present invention relates to a method, a wireless communication system, a communication apparatus, and a tangible machine-readable medium for establishing a routing path during a network entry process of a subscriber station (SS) based on a multi-hop relay standard.

2. Descriptions of the Related Art

Although the IEEE 802.16 standard already provides greater bandwidths, lower building cost, better service quality and expansibility, there still exist some defects of coverage and signal quality of the IEEE 802.16 standard. Therefore, the IEEE 802.16j standard working group established a multi-hop relay study group in July, 2005 for building a multi-hop relay standard.

In conventional IEEE 802.16 standard, network entry process is easily to execute because a base station (BS) and a plurality of subscriber stations (SSs) transmit data to each other directly. But in the multi-hop relay standard, such as the IEEE 802.16j standard or the IEEE 802.16m standard, there are relay stations (RSs) to relay data between the BS and the SSs. Accordingly, the routing paths between the BS and the SSs are more complicated because of data's relay, so that the network entry process will be more difficult between the BS and the SSs.

When an SS, such as a mobile station (MS), enters into a multi-hop relay stations (MR-RSs) network under the IEEE 802.16j during a network entry process, a solution to choosing and/or managing routing paths of the MR-RSs network under the IEEE 802.16j standard which transmit data from a BS to the SS is desired.

### SUMMARY OF THE INVENTION

One objective of this invention is to provide a method for establishing a routing path during a network entry process of an SS based on a multi-hop relay standard. The method comprises the following steps: transmitting a ranging request (RNG-REQ) of the SS with a ranging connection identification (CID) from the SS to an RS; allocating an SS CID for the SS; transmitting a ranging response (RNG-RSP) having the SS CID with the ranging CID from the RS to the SS; transmitting a request message with the SS CID from the SS to a BS through the RS; and transmitting a response message from the BS to the SS through the RS after receiving the request message. The routing path of the SS is updated into a routing table of the RS according to one of the request message and the response message.

Another objective of this invention is to provide a wireless communication system for establishing a routing path during a network entry process of an SS based on a multi-hop relay standard. The wireless communication system comprises a BS, an SS, and an RS. The SS transmits an RNG-REQ of the SS to the RS with a ranging CID. The RS allocates an SS CID for the SS, and transmits an RNG-RSP having the SS CID to the SS with the ranging CID. Then the SS transmits a request message with the SS CID to the BS through the RS. Finally, the BS transmits a response message to the SS through the RS after receiving the request message. The routing path of the SS is updated into a routing table of the RS according to one of the request message and the response message.

Another objective of this invention is to provide a communication apparatus for establishing a routing path during a network entry process of an SS based on a multi-hop relay standard. The communication apparatus comprises a receiving module, a memory, a processor, and a transmitting module. The receiving module receives a request message or a response message. The memory stores a routing table.

In one way, when the receiving module receives the request message, such as an SS basic capability request (SBC-REQ), the processor processes the request message to retrieval SS information having an SS CID and the routing path of the SS, and to update the SS CID and the routing path of the SS into the routing table. The transmitting module transmits the request message with the SS CID to the BS.

In the other way, when the receiving module receives the response message, such as an SS basic capability response (SBC-RSP), which has an SS CID and the routing path of the SS, the processor updates the SS CID and the routing path of the SS into the routing table after receiving the response message. Finally, the transmitting module transmits the response message with an RS CID to the SS.

Another objective of this invention is to provide a tangible machine-readable medium having executable code to cause a machine to perform a method for establishing a routing path during a network entry process of an SS based on a multi-hop relay standard. The method comprises the following steps: transmitting an RNG-REQ of the SS with a ranging CID from the SS to an RS; allocating an SS CID for the SS; transmitting an RNG-RSP having the SS CID with the ranging CID from the RS to the SS; transmitting a request message with the SS CID from the SS to a BS through the RS; and transmitting a response message from the BS to the SS through the RS after receiving the request message. The routing path of the SS is updated into a routing table of the RS according to one of the request message and the response message.

The aforesaid method can be executed by wireless communication apparatus, such as a BS or an RS in the wireless communication system. By receiving a request message (i.e. SBC-REQ) or a response message (i.e. SBC-RSP) and updating the SS CID and the routing path of the SS into a routing table which is stored in the RS, this invention can choose and/or manage routing paths of the RS of the wireless communication system. Thus, data of the wireless communication system based on a multi-hop relay standard can be transmitted successfully among the BS, RSs, and SSs.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 illustrates a multi-hop relay wireless communication system of a first embodiment of the present invention;

FIG. 2 illustrates a block diagram of an RS of the first embodiment;

FIG. 3 illustrates diagrams of data transmission of network entry process of an SS of the first embodiment;

FIG. 4 is a flow chart illustrating a second embodiment of the present invention;

FIG. 5 is a flow chart illustrating request message processing of the second embodiment; and

FIG. 6 is a flow chart illustrating response message processing of the second embodiment.

### DESCRIPTION OF THE PREFERRED EMBODIMENT

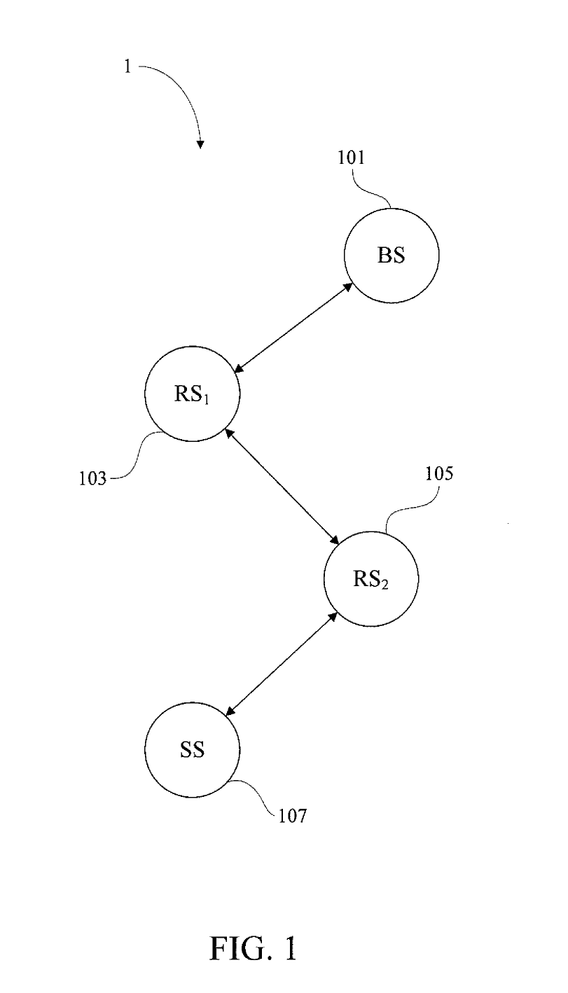

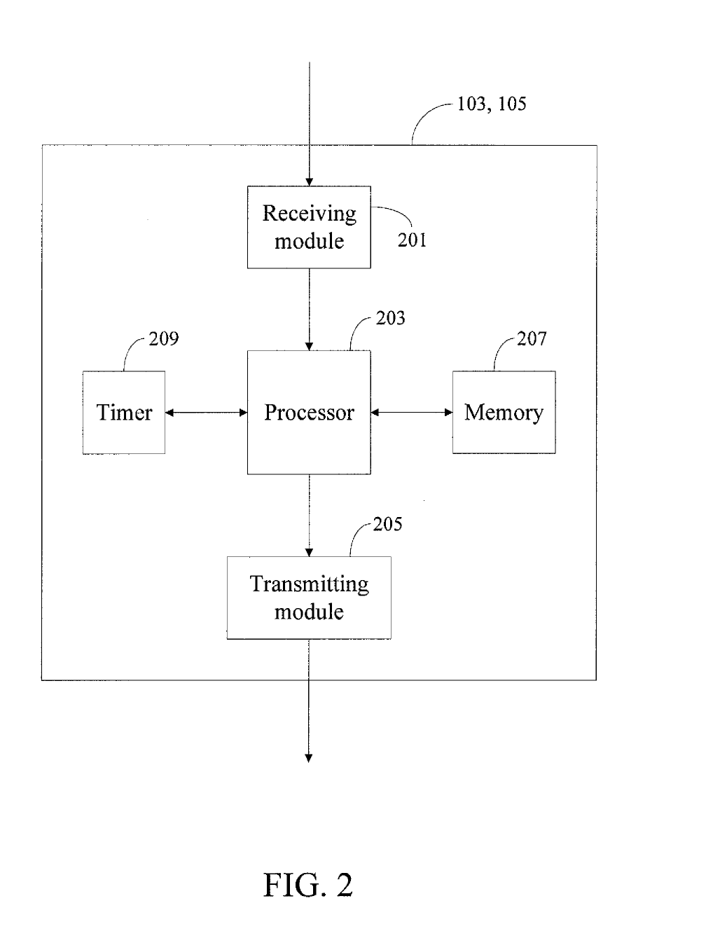

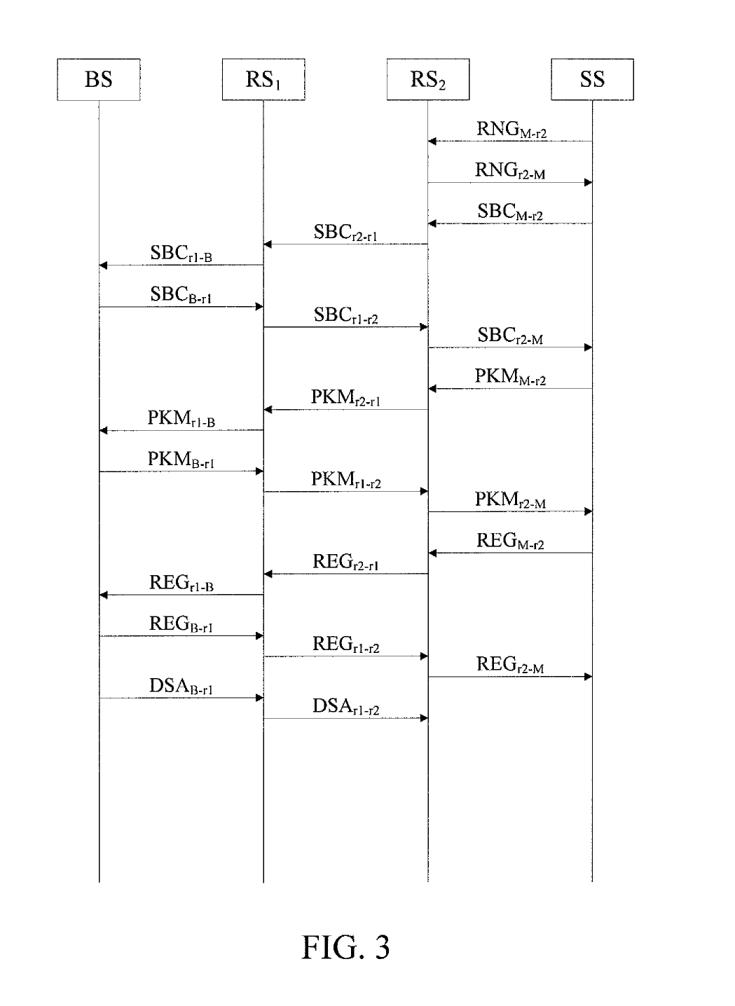

As illustrated in FIG. 1, a first embodiment of the present invention is a multi-hop relay wireless communication system 1 based on a multi-hop relay standard, such as IEEE 802.16j standard. The multi-hop relay wireless communication system 1 comprises a BS 101, a plurality of RSs 103, 105, and an SS 107. For the sake of simplification, two RSs (RS₁ 103, and RS₂ 105) are illustrated. The SS 107 can be an MS or another RS which can provide functions based on the multi-hop relay standard. The RSs 103, 105 of the multi-hop relay wireless communication system 1 is illustrated in FIG. 2, which comprises a receiving module 201, a processor 203, a transmitting module 205, a memory 207, and a timer 209. Data transmission of network entry process of the SS 107 based on the multi-hop relay wireless communication system 1 is illustrated in FIG. 3.

In FIG. 3, because the RS₁ 103 and the RS₂ 105 have entered into the multi-hop relay stations system 1, the SS 107 can execute the network entry process to enter into the multi-hop relay stations system 1 via the RS₁ 103 and the RS₂ 105. The SS 107 will select the nearest RS to connect so that the network entry process of the SS 107 will be executed in the shortest time period. In this embodiment, the nearest RS is the RS₂ 105. When starting the network entry process, the SS 107 transmits an RNG-REQ RNG_{M-r2} which comprises an SS MAC address of the SS 107 with a ranging CID to the RS₂. The ranging CID is used in the network entry process. After the receiving module 201 of the RS₂ 105 receives the RNG-REQ RNG_{M-r2} and the processor 203 of the RS₂ 105 processes the RNG-REQ RNG_{M-r2}, the RS₂ 105 will allocate an SS basic CID and an SS primary CID for the SS 107. Then the RS₂ 105 transmits an RNG-RSP RNG_{r2-M} which comprises the SS basic CID and the SS primary CID of the SS 107 with HMAC/CMAC with the ranging CID to the SS 107, so that the SS 107 will be assigned the SS basic CID and the SS primary CID.

Then, the SS 107 transmits one request message, such as an SBC-REQ SBC_{M-r2} with the SS basic CID to the RS₂ 105, the RS₂ 105 transmits another request message, such as an SBC-REQ SBCᵣ₂₋ᵣ₁ which comprises the SS information (i.e. SS MAC address) with the SS basic CID to the RS₁ 103, and the RS₁ 103 transmits the other request message, such as an SBC-REQ SBC_{r1-B} which comprises the SS information with the SS basic CID to the BS 101.

After processing the SBC-REQ SBC_{r1-B}, the BS 101 transmits one response message, such as an SBC-RSP SBC_{B-r1} which comprises the SS basic CID, the SS primary CID, and a routing path of the SS 107 with HMAC/CMAC with an RS₁ CID to the RS₁ 103. After that, the RS₁ 103 transmits another response message, such as an SBC-RSP SBCᵣ₁₋ᵣ₂ which comprises the SS basic CID and the SS primary CID with HMAC/CMAC with an RS₂ CID to the RS₂ 105. Finally, the RS₂ 105 transmits the other response message, such as an SBC-RSP SBC_{r2-M} to the SS 107 with the SS basic CID.

There are two ways to update the SS basic CID, the SS primary CID, and the routing path of the SS 107 into a routing table which is stored in the memory 207 of the RS₁ 103. One way is that the processor 203 of the RS₁ 103 processes the SBC-REQ SBCᵣ₂₋ᵣ₁ to retrieval the SS information. Then the RS₁ 103 updates the SS basic CID, the SS primary CID, and the routing path of the SS 107 into the routing table according to the SBC-REQ SBCᵣ₂₋ᵣ₁ and the SS information.

Another way is that the RS₁ 103 updates the SS basic CID, the SS primary CID, and the routing path of the SS 107 into the routing table according to the SBC-RSP SBC_{B-r1} and the SS information after the receiving module 201 of the RS₁ 103 receives the SBC-RSP SBC_{B-r1}.

After the routing table of the RS₁ 103 is updated, a timer 209 of the RS₁ 103 starts a timeout period to wait the BS 101 to transmit a dynamic service addition request (DSA-REQ). Similarly, a timer 209 of the RS₂ 105 starts another timeout period to wait the BS 101 to transmit a DSA-REQ through the RS₁ 103.

This invention is not limited that only the routing table the RS₁ 103 is updated, any other RSs (i.e. RS₂ 105) in the multi-hop relay wireless communication system 1 also can update the routing table thereof as the operations described in the above description. Those skilled in the art can understand the corresponding operations of the update of the routing table by the explanation of the first embodiment.

Second, the SS 107 transmits a PKM-REQ PKM_{M-r2} with the SS primary CID to the RS₂ 105, the RS₂ 105 transmits a PKM-REQ PKMᵣ₂₋ᵣ₁ with the SS primary CID to the RS₁ 103, and the RS₁ 103 transmits a PKM-REQ PKM_{r1-B} with the SS primary CID to the BS 101. After processing the PKM-REQ PKM_{r1-B}, the BS 101 transmits a PKM-RSP PKM_{B-r1} with the SS primary CID to the RS₁ 103, the RS₁ 103 transmits a PKM-RSP PKMᵣ₁₋ᵣ₂ with the SS primary CID to the RS₂ 105, and the RS₂ 105 transmits a PKM-RSP PKM_{r2-M} with the SS primary CID to the SS 107.

Third, the SS 107 transmits an REG-REQ REG_{M-r2} with HMAC/CMAC with the SS primary CID to the RS₂ 105, the RS₂ 105 transmits an REG-REQ REGᵣ₂₋ᵣ₁ with HMAC/CMAC with the SS primary CID to the RS₁ 103, and the RS₁ 103 transmits an REG-REQ REG_{r1-B} with HMAC/CMAC with the SS primary CID to the BS 101. After processing the REG-REQ REG_{r1-B}, the BS 101 transmits an REG-RSP REG_{B-r1} with HMAC/CMAC with the SS primary CID to the RS₁ 103, the RS₁ 103 transmits an REG-RSP REGᵣ₁₋ᵣ₂ with HMAC/CMAC with the SS primary CID to the RS₂ 105, and the RS₂ 105 transmits an REG-RSP REG_{r2-M} with HMAC/CMAC with the SS primary CID to the SS 107.

Finally, the BS 101 transmits a DSA-REQ DSA_{B-r1} which comprises the SS basic CID with HMAC/CMAC with the RS₂ primary CID to the RS₁ 103 and the RS₁ 103 transmits a DSA-REQ DSAᵣ₁₋ᵣ₂ which comprises the SS basic CID with HMAC/CMAC with the RS₂ primary CID to the RS₂ 105. If the RS₁ 103 receives the DSA-REQ DSA_{B-r1} in the timeout period which is started by the timer 209 of the RS₁ 103, the SS basic CID, the SS primary CID, and the routing path of the SS 107 stored in the routing table of the RS₁ 103 will be kept. Otherwise, if the RS₁ 103 receives the DSA-REQ DSA_{B-r1} out of the timeout period which is started by the timer 209 of the RS₁ 103, the SS basic CID, the SS primary CID, and the routing path of the SS 107 stored in the routing table of the RS₁ 103 will be removed.

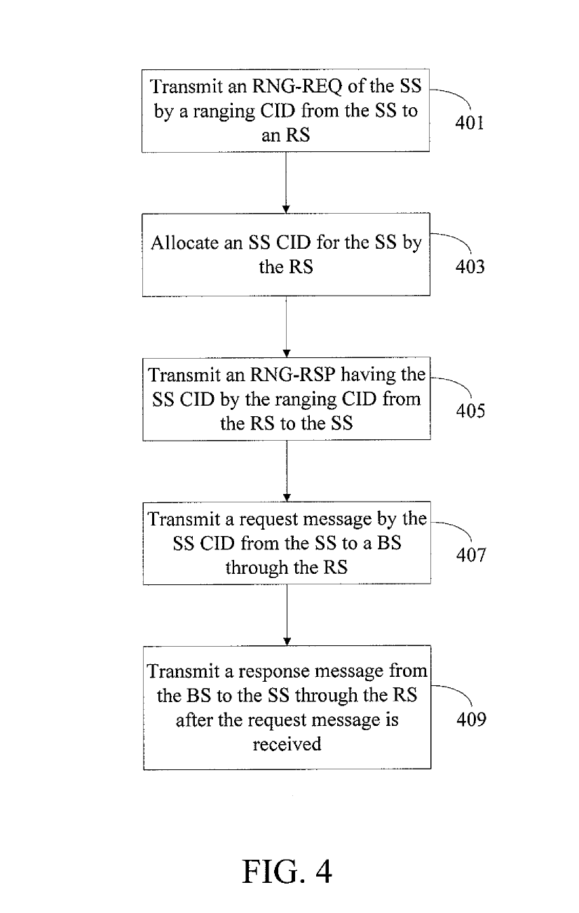

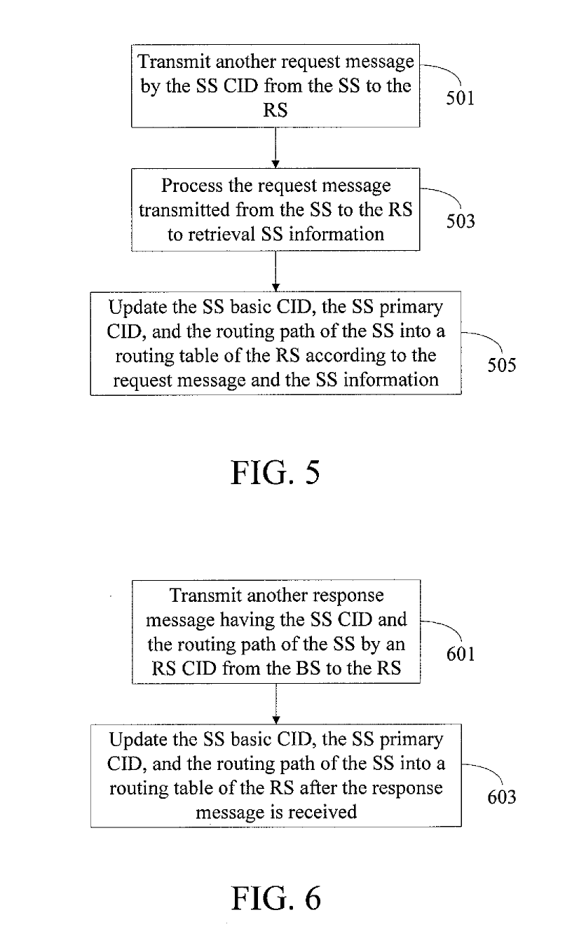

A second embodiment of this invention is a method for establishing a routing path during a network entry process of an SS based on a multi-hop relay standard, which is a method applied to the multi-hop relay wireless communication system 1 described in the first embodiment. More specifically, the method of the second embodiment which is illustrated in FIG. 4, FIG. 5, and FIG. 6 can be implemented by an application program controlling various modules of a wireless communication apparatus in the multi-hop relay wireless communication system 1. This application program may be stored in a tangible machine-readable medium, such as a read only memory (ROM), a flash memory, a floppy disk, a hard disk, a compact disk, a mobile disk, a magnetic tape, a database accessible to networks, or any other storage media with the same function and well known to those skilled in the art.

In step 401, an RNG-REQ of the SS, such as the SS 107, is transmitted with a ranging CID from the SS to an RS, Next in step 403, an SS CID for the SS is allocated by the RS. In step 405, an RNG-RSP having the SS CID is transmitted with the ranging CID from the RS to the SS. Then, in step 407, a request message (i.e. SBC-REQ) is transmitted with the SS CID from the SS to a BS, such as the BS 101, through the RS. Finally, in step 409, a response message (i.e. SBC-RSP) is transmitted from the BS to the SS through the RS after the request message is received.

One way to update the SS basic CID, the SS primary CID, and the routing path of the SS, step 407 further comprises some steps illustrated in FIG. 5. In step 501, another request message is transmitted with the SS CID from the SS to the RS. In step 503, the request message transmitted from the SS to the RS is processed to retrieval SS information. Finally, in step 505, the SS basic CID, the SS primary CID, and the routing path of the SS are updated into a routing table of the RS according to the request message and the SS information.

Another way to update the SS basic CID, the SS primary CID, and the routing path of the SS, step 409 further comprises some steps illustrated in FIG. 6. In step 601, another response message having the SS CID and the routing path of the SS is transmitted with an RS CID from the BS to the RS. In step 603, the SS basic CID, the SS primary CID, and the routing path of the SS are updated into a routing table of the RS after the RS receives the response message.

In addition to the steps revealed in FIG. 4, FIG. 5, and FIG. 6, the second embodiment can also execute all the operations of the first embodiment, in which those skilled in the art can understand the corresponding steps and operations of the second embodiment by the explanation of the first embodiment, and thus no necessary detail is given.

Accordingly, by receiving an SBC-REQ or an SBC-RSP, and updating the SS CID and the routing path of the SS into a routing table which is stored in the RS, this invention can choose and/or manage relay paths of the RS of the wireless communication system. Thus, data of the wireless communication system based on a multi-hop relay standard can be transmitted successfully among the BS, RSs, and SSs.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A method for establishing a routing path during a network entry process of a subscriber station (SS) based on a multi-hop relay standard, comprising the steps of:
transmitting a ranging request (RNG-REQ) of the SS with a ranging connection identification (CID) from the SS to a first relay station (RS);
allocating an SS CID for the SS;
transmitting a ranging response (RNG-RSP) having the SS CID with the ranging CID from the first RS to the SS;
transmitting a request message with the SS CID from the SS to a base station (BS) through the first RS; and
transmitting a response message from the BS to the SS through the first RS after receiving the request message;
wherein the routing path of the SS is updated into a routing table of the first RS according to one of the request message and the response message.

2. The method as claimed in claim 1, wherein the request message is an SS basic capability request (SBC-REQ), and the response message is an SS basic capability response (SBC-RSP).

3. The method as claimed in claim 1, wherein the step of transmitting the request message further comprises the steps of:
transmitting the request message with the SS CID from the SS to the first RS;
processing the request message to retrieval SS information; and
updating the SS CID and the routing path of the SS into the routing table of the first RS according to the request message and the SS information.

4. The method as claimed in claim 1, wherein the step of transmitting the response message further comprises the steps of:
transmitting the response message having the SS CID and the routing path of the SS with a first RS CID from the BS to the first RS; and
updating the SS CID and the routing path of the SS into the routing table of the first RS after receiving the response message.

5. The method as claimed in claim 1, wherein the SS CID is one of an SS basic CID and an SS primary CID.

6. The method as claimed in claim 1, wherein the SS is one of a second RS and a mobile station (MS).

7. A wireless communication system for establishing a routing path during a network entry process of an SS based on a multi-hop relay standard, comprising:
a first RS having a routing table;
a BS; and
an SS being configured to transmit an RNG-REQ of the SS to the first RS with a ranging CID;
wherein the first RS allocates an SS CID for the SS, and transmits an RNG-RSP having the SS CID to the SS with the ranging CID, the SS transmits a request message with the SS CID to the BS through the first RS, and the BS transmits a response message to the SS through the first RS after receiving the request message;
wherein the routing path of the SS is updated into a routing table of the first RS according to one of the request message and the response message.

8. The wireless communication system as claimed in claim 7, wherein the request message is an SBC-REQ, and the response message is an SBC-RSP.

9. The wireless communication system as claimed in claim 7, wherein the SS transmits the request message to the first RS with the SS CID, the first RS processes the request message to retrieval SS information, and updates the SS CID and the routing path of the SS into the routing table of the first RS according to the request message and the SS information.

10. The wireless communication system as claimed in claim 7, wherein the BS transmits the response message having the SS CID and the routing path of the SS to the first RS with an RS CID, and the first RS updates the SS CID and the routing path of the SS into the routing table of the first RS after receiving the response message.

11. The wireless communication system as claimed in claim 7, wherein the SS CID is one of an SS basic CID and an SS primary CID.

12. The wireless communication system as claimed in claim 7, wherein the SS is one of a second RS and an MS.

13. A communication apparatus for establishing a routing path during a network entry process of an SS based on a multi-hop relay standard, comprising:
a receiving module being configured to receive a request message;
a memory being configured to store a routing table;
a processor being configured to process the request message to retrieval SS information having an SS CID and the routing path of the SS, and to update the SS CID and the routing path of the SS into the routing table; and
a transmitting module being configured to transmit the request message with the SS CID to the BS.

14. The communication apparatus as claimed in claim 13, wherein the request message is an SBC-REQ.

15. The communication apparatus as claimed in claim 13, further comprising:
a timer for starting a timeout period after the SS CID and the routing path of the SS are updated;
wherein when the receiving module receives a DSA-REQ having the SS CID with an RS CID in the timeout period, the SS CID and the routing path are still kept in the routing table.

16. A communication apparatus for establishing a routing path during a network entry process of an SS based on a multi-hop relay standard, comprising:
a receiving module being configured to receive a response message having an SS CID and the routing path of the SS;
a memory being configured to store a routing table;
a processor being configured to update the SS CID and the routing path of the SS into the routing table after receiving the response message; and
a transmitting module being configured to transmit the response message with an RS CID to the SS.

17. The communication apparatus as claimed in claim 16, wherein the response message is an SBC-RSP.

18. The communication apparatus as claimed in claim 16, further comprising:
a timer for starting a timeout period after the SS CID and the routing path of the SS are updated;
wherein when the receiving module receives a DSA-REQ having the SS CID with an RS CID in the timeout period, the SS CID and the routing path are still kept in the routing table.

19. A tangible machine-readable medium having executable code to cause a machine to perform a method for establishing a routing path during a network entry process of an SS based on a multi-hop relay standard, the method comprising steps of:
transmitting an RN G-REQ of the SS with a ranging CID from the SS to a first RS;
allocating an SS CID for the SS;
transmitting an RNG-RSP having the SS CID with the ranging CID from the first RS to the SS;
transmitting a request message with the SS CID from the SS to a BS through the first RS; and
transmitting a response message from the BS to the SS through the first RS after receiving the request message;
wherein the routing path of the SS is updated into a routing table of the first RS according to one of the request message and the response message.

20. The tangible machine-readable medium as claimed in claim 19, wherein the request message is an SBC-REQ, and the response message is an SBC-RSP.

21. The tangible machine-readable medium as claimed in claim 19, wherein the step of transmitting the request message further comprises the steps of:
transmitting the request message with the SS CID from the SS to the first RS;
processing the request message to retrieval SS information; and
updating the SS CID and the routing path of the SS into the routing table of the first RS according to the request message and the SS information.

22. The tangible machine-readable medium as claimed in claim 19, wherein the step of transmitting the response message further comprises the steps of:
transmitting the response message having the SS CID and the routing path of the SS with a first RS CID from the BS to the first RS; and
updating the SS CID and the routing path of the SS into the routing table of the first RS after receiving the response message.

23. The tangible machine-readable medium as claimed in claim 19, wherein the SS CID is one of an SS basic CID and an SS primary CID.

24. The tangible machine-readable medium as claimed in claim 19, wherein the SS is one of a second RS and an MS.
